(19) United States
(12) Patent Application Publication
(10) Pub. No.: US 2024/0260142 A1
(43) Pub. Date: Aug. 1, 2024

(54) FLOW HEATER

(71) Applicant: BorgWarner Inc., Auburn Hills, MI (US)

(72) Inventors: Carlos Castaño, Vigo (ES); Xoán Hermida, Gondomar (ES); Marta Lagüela López, Vigo (ES); José Pérez, Vigo (ES); Carlos Viñas, Vigo (ES); Germán Troncoso, Vigo (ES)

(21) Appl. No.: 18/417,399

(22) Filed: Jan. 19, 2024

(30) Foreign Application Priority Data
Jan. 27, 2023 (EP) 23 153 618.6

(51) Int. Cl. H05B 3/26

(52) U.S. Cl. CPC H05B 3/265; H05B 2203/003; H05B 2203/021

(57) ABSTRACT

Disclosed is a flow heater including a housing having an inlet and an outlet, and an electrical heating resistor provided as conductive tracks. The housing has a first housing part made of a deep drawn sheet of metal and a second housing part made of a sheet of metal, and the heating resistor is arranged as conductive tracks on the first housing part or the second housing part.

### RELATED APPLICATIONS

This application claims priority to EP 23 153 618.6, filed Jan. 27, 2023, the entire disclosure of which is hereby incorporated herein by reference.

### BACKGROUND

The disclosure relates to flow heaters of the type generally known, for example, from U.S. Publication No. 2022/0099336 A1.

Flow heaters are required, for example, in cars, in order to heat various liquids, in particular water or aqueous solutions. Flow heaters in electric cars usually have an operating voltage of several hundred volts, e.g., 400 V to 800 V. Constant objectives in the development of flow heaters for cars are: a compact design, low manufacturing costs and a high efficiency, such that a large quantity of liquid can be heated up in a short time.

### SUMMARY

This disclosure teaches a flow heater for cars that has a compact design, low manufacturing costs and a high efficiency, such that a large quantity of liquid can be heated in a short time.

A flow heater according to this disclosure comprises a housing having an inlet and an outlet. In operation, liquid to be heated flows from the inlet through the interior of the housing to the outlet. The housing comprises a first housing part made of a deep drawn sheet of metal, a second housing part made of a sheet of metal, wherein the heating resistor is provided as conductive tracks arranged on the first housing part or the second housing part, e.g., on a dry side of the housing.

A housing made of sheet metal can be produced more cost efficiently than molded housings of prior art flow heaters and also with a lower weight. Moreover, by providing the heating resistor as conductive tracks on one of the housing parts further reductions in manufacturing costs can be achieved as no separate substrate is needed for the heating resistor. Instead, the housing itself is the substrate on which conductive tracks are arranged, for example, by printing or thermal spraying. The area of the housing on which the conductive tracks are arranged is covered by an electrically insulating layer, e.g., a glass or ceramic layer that may be applied by chemical vapor deposition, physical vapor deposition or thermal spraying.

Thermal spraying techniques are coating processes in which materials are sprayed onto a surface that have been heated. Processes wherein the material has been heated via electrical means are usually called plasma or arc spraying. Processes wherein material has been heated by chemical means are usually called flame spraying.

Both the first housing part and the second housing part may be deep drawn metal sheets. However, it is sufficient if the first housing part is a deep drawn metal sheet. The second housing part may also be a plate that together with the first housing part encloses an interior for liquid to be heated. The first housing part and the second housing part may be connected by welding or by brazing, for example.

In a refinement of this disclosure, the inlet and the outlet are provided on the first housing part. Inlet and outlet can be especially cost-efficiently provided in a housing part that is a deep drawn metal sheet. It is also possible to provide the inlet and the outlet on different housing parts, e.g., the inlet on the first housing part and the outlet on the second housing part, or both the inlet and the outlet on the second housing part.

In another refinement of this disclosure, fins may be arranged in an interior of the housing in order to improve heat transfer to the liquid to be heated. Assembly of the flow heater is facilitated if the fins are fixed to one of the housing parts, e.g., the housing part on which the heating resistor is arranged. The fins may be connected to the housing by welding or brazing, for example. The fins may be made of corrugated sheet metal, for example.

In another refinement of this disclosure, the second housing part has a cut-out through which an electrical connector protrudes that is electrically connected to the heating resistor. The cut-out may, for example, be a window, e.g., a slit removed from an edge of the housing part, or a recess provided in an edge of the housing part.

In a further refinement of this disclosure, the housing may be enclosed in an outer housing, e.g., an outer housing made of metal and/or of plastic. Especially if the flow heater is configured for high voltage, an outer housing can be used to facilitate electrical insulation and protect delicate parts of the flow heater from damage, like, e.g., the heating resistor or control electronics that may be arranged on a circuit board. The outer housing may be a two-part housing. Both parts of the outer housing may be made of plastic. It is also possible to make both parts of the outer housing of metal or one part of plastic and the other of metal.

In a further refinement of this disclosure, the flow heater comprises a circuit board with control electronics. The circuit board may have two openings through which nozzles connected to the inlet and the outlet, respectively, protrude. This facilitates a very compact design. Such nozzles may also protrude through the outer housing.

The first housing part, the second housing part, fins, and nozzles (if present) may be made of aluminum or an aluminum-based alloy. In this way, the weight of the flow heater can be advantageously low. Moreover, these components can be connected cost-efficiently by brazing. Thermal spraying is a method for creating conductive tracks that works well on an aluminum substrate. Hence, by means of thermal spraying, conductive tracks can be provided on one of the housing parts, e.g., the second housing part.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a flow heater in a perspective view;

FIG. 2 is an exploded perspective view of the flow heater shown in FIG. 1;

FIG. 3 is an exploded perspective view of the housing of the flow heater shown in FIG. 2; and

FIG. 4 is a plan view showing the lower part of the housing shown in FIG. 3 viewed from the outside.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

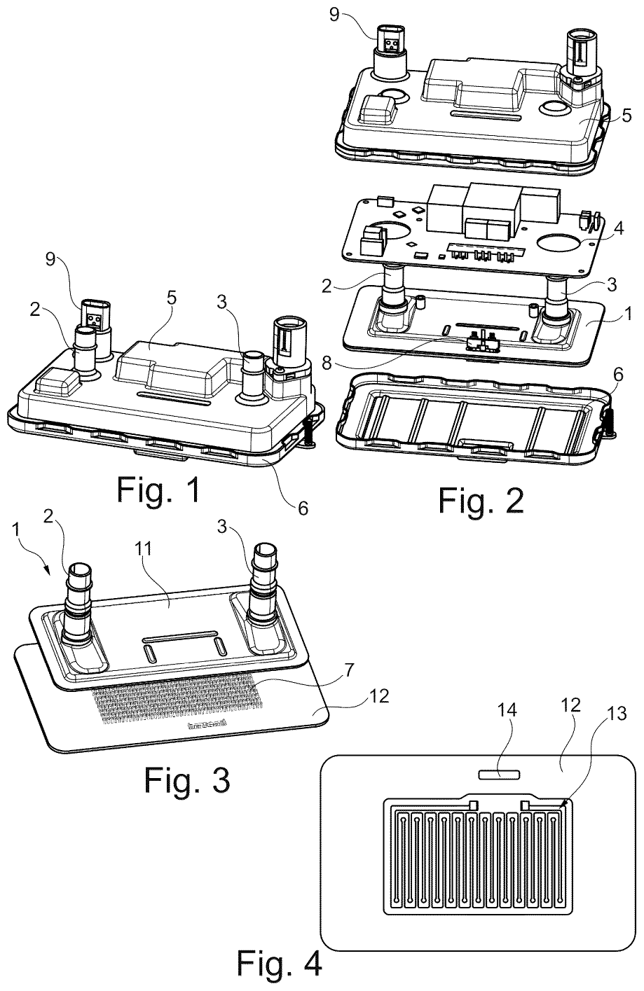

The flow heater shown in FIGS. 1 and 2 comprises a housing 1 that has an inlet connected to a nozzle 2 and an outlet connected a nozzle 3, a printed circuit board 4 with control electronics, and an outer housing that comprises a first outer housing part 5 and a second outer housing part 6. An exploded view of the housing 1 is shown in FIG. 3. The housing 1 comprises a first housing part 11 and a second housing part 12. On a dry side (outer side) of the second housing part 12 is a heating resistor 13 provided as a layer in the form of conductive tracks as shown in FIG. 4.

The first housing part 11 is a metal sheet that has been shaped by deep drawing to provide a cavity as well as an inlet and an outlet. A nozzle 2 is connected to the inlet and a nozzle 3 to the outlet. The cavity provided by the first housing part 11 is closed by the second housing part 12 which, in the embodiment shown is a plate-shaped metal sheet, but might in a different embodiment also be shaped by deep drawing.

The second housing part 12 carries fins 7 on its inside, i.e., its side facing the first housing part 11. The fins 7 may be made of corrugated sheet metal, for example. The housing 1 may be a two-part housing.

In operation, liquid to be heated flows from nozzle 2 via the inlet through the interior of housing 1 to the outlet and nozzle 3. Thereby heat created by the heating resistor 13 flows through the second housing part 12 and the fins 7 to the liquid surrounding the fins 7 inside the housing 1.

The first housing part 11 and the second housing part 12, the nozzles 2, 3 as well as the fins 7 may be made of metal, especially aluminum or an aluminum-based alloy. Brazing may be used to fix the fins 7 to the second housing part 12, the nozzles 2, 3 to the first housing part 12, and to connect the first housing part 11 and the second housing part 12. An advantage of connecting these parts of the flow heater by brazing is that no separate seals are needed.

The conductive tracks forming the heating resistor 13 may be created by thermal spraying onto an electrically insulating layer covering a dry side (outside) or part of the dry side of the second housing part 12. The electrically insulating layer may be a glass layer or a ceramic layer, for example, and be deposited on the second housing part 12 by chemical methods or physical methods, e.g., vapor deposition or thermal spraying. The heating resistor may be a metal alloy, e.g., an iron-based alloy comprising chromium or a nickel-based alloy comprising chromium. The electrically insulating layer may, for example, be based on aluminum oxide.

Operation of the heating resistor 13 is controlled by control electronics arranged on printed circuit board 4. The printed circuit board 4 is connected to the heating resistor by means of a connector 8 shown in FIG. 2. Connector 8 protrudes through a cut-out 14, e.g., a slit, provided in the second housing part 12. Pins of the connector 8 are electrically connected on one end to the resistor by brazing, soldering or other suitable means, on the other end the pins may form be inserted into holes of the circuit board 4. The pins inserted into holes of the circuit board 4 may form a press-fit connection with the circuit board 4, e.g., a connection by means of an interference fit, or a spring contact.

The printed circuit board 4 has two openings through which the nozzles 2, 3 protrude. The printed circuit board 4 and the housing 1 are enclosed in an outer housing. The outer housing comprises a first outer housing part 5 and a second outer housing part 6 which may be connected by a snap fit connection, for example. The outer housing parts 5, 6 may be made of plastic.

The first outer housing part 5 has an opening through which the nozzle 2 connected to the inlet of the housing 1 and the nozzle 3 connected to the outlet of the housing 1 protrude. The first outer housing part 5 may also provide sockets 9 for electrical connectors, e.g., plug connectors for connecting the control electronics and the resistor 13 to electrical power.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SIGNS

1 housing
2 nozzle
3 nozzle
4 circuit board
5 first outer housing part
6 second outer housing part
7 fins
8 connector
9 socket
11 first housing part
12 second housing part
13 heating resistor
14 cut-out

What is claimed is:

1. A flow heater, comprising:
a housing having an inlet and an outlet; and
an electrical heating resistor provided as conductive tracks;
wherein the housing comprises a first housing part made of a deep drawn sheet of metal and a second housing part made of a sheet of metal; and
wherein the conductive tracks are arranged on the first housing part and/or the second housing part.

2. The flow heater according to claim 1, wherein the heating resistor is provided on a dry side of one of the housing parts.

3. The flow heater according to claim 1, wherein the first housing part and the second housing part are connected by brazing.

4. The flow heater according to claim 1, wherein the second housing part carries fins protruding into an interior volume of the housing.

5. The flow heater according to claim 1, wherein the inlet and the outlet are provided on the first housing part.

6. The flow heater according to claim 1, wherein the heating resistor is provided on the second housing part.

7. The flow heater according to claim 1, wherein the second housing part has a cut-out through which an electrical connector protrudes that is electrically connected to the heating resistor.

8. The flow heater according to claim 1, further comprising a circuit board and an outer housing, wherein the housing and the circuit board are enclosed by the outer housing.

9. The flow heater according to claim 8, wherein the outer housing is a two-part housing comprising a first outer housing part and a second outer housing part.

10. The flow heater according to claim 8, wherein the outer housing is made of plastic.

11. The flow heater according to claim 7, wherein the connector is connected to the heating resistor by soldering or brazing and to the circuit board by pins inserted into holes of the circuit board.

12. The flow heater according to claim 7, wherein the circuit board and the outer housing each comprise two openings through which nozzles connected to the inlet and the outlet, respectively, protrude.

13. The flow heater according to claim 11, wherein the nozzles are brazed to the first housing part and the fins are brazed to the second housing part, and wherein the first housing part, the second housing part, the fins and the nozzles are made of an aluminum alloy.

14. A flow heater, comprising:
a housing having an inlet and an outlet; and
an electrical heating resistor;
wherein the housing comprises a first housing part made of a deep drawn sheet of metal and a second housing part made of a sheet of metal;
the heating resistor arranged as conductive tracks on the first housing part and/or the second housing part; and
the second housing part having a cut-out through which an electrical connector protrudes that is electrically connected to the heating resistor.
